(19) United States
(12) Patent Application Publication
(10) Pub. No.: US 2017/0220340 A1
(43) Pub. Date: Aug. 3, 2017

(54) INFORMATION-PROCESSING SYSTEM, PROJECT RISK DETECTION METHOD AND RECORDING MEDIUM

(71) Applicant: NEC Corporation, Tokyo (JP)

(72) Inventors: Ayako HOSHINO, Tokyo (JP); Takashi SHIRAKI, Tokyo (JP)

(73) Assignee: NEC Corporation, Tokyo (JP)

(21) Appl. No.: 15/500,679

(22) PCT Filed: Aug. 4, 2015
(86) PCT No.: PCT/JP2015/003916

§ 371 Date: Jan. 31, 2017

(30) Foreign Application Priority Data
Aug. 6, 2014 (JP) 2014-160068

(51) Int. Cl. G06F 9/44; G06Q 10/06

(52) U.S. Cl. CPC G06F 8/77; G06Q 10/0635

(57) ABSTRACT

Provided is an information processing system for detecting a project risk more preferably with fewer input information. The system includes: feature representation totalizing means that totalizes an occurrence frequency of a feature representation related to each process based on a set of a message and a time of occurrence of the message, and on feature representation information indicating the feature representation related to the process; and discrepancy determination means that outputs information about discrepancy between ideal and actual states of the process based on an occurrence rate calculated from the occurrence frequency related to the process and on a detection rule that defines a position of the occurrence rate on a time axis.

### TECHNICAL FIELD

The present invention relates to a technique for detecting a risk in a project with regard to progress of a project.

### BACKGROUND ART

There have been known technologies for detecting risks in projects, and various related techniques relating to detection of risks in projects.

For example, an information-processing apparatus that supports risk prediction of PTL 1 is connected to a network to which a terminal used by a project member is connected, as illustrated in FIG. 1 of PTL 1. The information-processing apparatus includes a resource information accumulation unit, a project information accumulation unit, an arithmetic processing unit, and a communication information accumulation unit. Further, the arithmetic processing unit includes a communication information representation unit and a communication information extraction unit.

The information-processing apparatus of PTL 1, including such a configuration, operates as described below. When any terminal transmits a message, the arithmetic processing unit stores communication information relating to the message in the communication information accumulation unit. Further, the arithmetic processing unit outputs analysis information that represents the number of times a person concerned with a project has sent a message in time series, corresponding to each person concerned with the project, on the basis of accumulation information in the communication information accumulation unit.

A risk detection system of PTL 2 includes a project-related information storage unit, a risk information storage unit, an intention representation dictionary storage unit, means for determining the intention of a speech sentence, and topic representation dictionary storage unit, as illustrated in FIG. 1 of PTL 2. The risk detection system further includes means for determining the topic of a speech sentence, a high-risk speech specification rule storage unit, and high-risk speech specification means.

The risk detection system of PTL 2 including such a configuration operates as described below. The intention determination means determines intentions included in corresponding text sentences stored in the project-related information storage unit. Then, the topic determination means determines the topic of each speech. Then, the high-risk speech specification means uses information of an intention assigned to each speech and the topic to determine whether the speech is a speech relevant to the high risk in the project. The high-risk speech specification means executes determination whether the speech is a high-risk speech, on the basis of a rule including combinations of intentions and topics stored in the high-risk speech specification rule storage unit.

A project management apparatus of PTL 3 includes a task registration unit, a task storage unit, a task crawler, a task extraction unit, a setting unit, and a display unit, as illustrated in FIG. 3 of PTL 3. The project management apparatus of PTL 3 including such a configuration operates as described below. First, the task storage unit stores task information including an update history of a task. Second, the task extraction unit extracts a task of which the frequency of updating the task information is greater than a predetermined value, and a task of which the frequency of updating the task information is zero, during a predetermined period, on the basis of the update history of the task information. In such a case, the task extraction unit processes the task information obtained via the task crawler, and extracts the tasks according to settings set by the setting unit.

An analysis tool of NPL 1 includes a data source storage unit, a syntax analyzer, a TAPoR (Text Analysis Portal for Research) natural language analysis platform, and a category glossary dictionary, as illustrated in FIG. 1 of NPL 1. The analysis tool further includes an annotated XML (Extensible Markup Language) storage unit, XQuery (XML Query), and a pattern storage unit. The analysis tool further includes pattern extraction means and an RDF (Resource Description Framework) triple storage unit.

The analysis tool of NPL 1 executes the following processing. First, the analysis tool subjects an input text document with a transmission time and date to syntax analysis, natural language analysis, annotation by a category, and pattern matching, and extracts valuable information. Second, the analysis tool stores the extracted information as a triple (three-piece set of subject, predicate, and object) of RDF in the RDF triple storage unit.

As described above, a system user can confirm information about actual state of implementation of a project by variously querying the RDF triple storage unit.

An email analysis technique of NPL 2 is a technique using a data converter, a clustering tool, and a project replayer, as illustrated in FIG. 3 of NPL 2.

In the email analysis technique of NPL 2, each tool operates as described below. The data converter converts an input text document with a transmission time and date into a data format referred to as document vectors which are strings of the frequencies of occurrence of words. Then, the clustering tool collects the document vectors in plural document groups. Then, the project replayer visualizes the document groups in a time series or a tree diagram.

As described above, a system user can confirm information about the actual state of the implementation of a project.

### CITATION LIST

### Patent Literature

[PTL 1] Japanese Patent Laid-Open No. 2004-054606

[PTL 2] Japanese Patent Laid-Open No. 2008-210367

[PTL 3] Japanese Patent Laid-Open No. 2009-251899

### Non Patent Literature

[NPL 1] Maryam Hasan, Eleni Stroulia, Denilson Barbosa, Manar Alalfi (University of Alberta, Canada), “Analyzing Natural-Language Artifacts of the Software Process”, IEEE International Conference on Software Maintenance, September 2010.
[NPL 2] Kimiharu Ohkura, Shinji Kawaguchi, and Hajimu Iida (Nara Institute of Science and Technology) “A Method for Visualizing Contexts in Software Development using Clustering Email Archives”, SEC Journal Vol. 6, No. 3, 2010, pp. 134-143

### SUMMARY OF INVENTION

### Technical Problem

Risk detection in a project requires fewer requests for input information necessary for the risk detection, and requires an output of more preferably detected risk information. Such a risk in the project is that an ideal state and an actual state of a step in the process become discrepant from each other, e.g., the risk is that design is begun without sufficient definition of requirements, or implementation is begun without sufficient design.

However, techniques described in the Citation List described above have following problems.

The information-processing apparatus of PTL 1 has a problem of being unable to detect a project risk unless the project risk is represented by the number of times of message sending. This is because it is impossible to detect the risk, even if the problem of the progress of the project is expressed by the content of a message, unless a variation such as the significantly small or sharply increased number of times of message sending.

The risk detection system of PTL 2 has a problem of being unable to perform detection unless a problem or a concern is explicitly represented in the content of a message. Therefore, for example, a project member can use no specific intention representation to thereby prevent a risk from being detected. This is because such a risk detection system detects a risk by using an intention representation dictionary representing problems and concerns to pattern-match representations in the dictionary to messages.

The project management apparatus of PTL 3 has a problem of being unable to detect a project risk unless the frequency of updating task information is specific. This is because a task of which the frequency of updating the task information is greater than a predetermined value, and a task of which the frequency of updating the task information is zero, during a predetermined period, are extracted as tasks to be closely observed.

The techniques disclosed in NPL 1 and NPL 2 have a problem that a user is unable to find a project risk unless the user actively makes a search for the project risk. This is because these systems do not have a mechanism for defining what a project risk is and for detecting the project risk although the content of a message is converted into a structure which facilitates machine interpretation, such as the RDF triple or clustering, in the systems. Therefore, the techniques are unable to automatically detect the project risk.

An object of the present invention is to provide an information-processing system, a project risk detection method, and a program for the method, by which a project risk is more preferably detected and output based on general text information generated with the progress of a project; and to provide a non-transitory computer-readable recording medium on which the program is recorded.

### Solution to Problem

An information-processing system according to the invention includes:

feature representation totalizing means that totalizes an occurrence frequency of a feature representation relating to each process based on a set of a message and a time of occurrence of the message, and on feature representation information indicating the feature representation relating to the process; and

discrepancy determination means that outputs information about discrepancy between ideal and actual states of the process based on an occurrence rate calculated from the occurrence frequency relating to the process and on a detection rule that defines a position of the occurrence rate on a time axis.

A project risk detection method according to the invention includes:

totalizing an occurrence frequency of a feature representation relating to each process based on a set of a message and a time of occurrence of the message, and on feature representation information indicating the feature representation relating to the process; and

outputting information about discrepancy between ideal and actual states of the process based on an occurrence rate calculated from the occurrence frequency relating to the process and on a detection rule that defines a position of the occurrence rate on a time axis.

A non-transitory computer-readable recording medium on which a program is recorded that causes a computer to execute:

processing of totalizing an occurrence frequency of a feature representation relating to each process based on a set of a message and a time of occurrence of the message, and on feature representation information indicating the feature representation relating to the process; and

processing of outputting information about discrepancy between ideal and actual states of the process based on an occurrence rate calculated from the occurrence frequency relating to the process and on a detection rule that defines a position of the occurrence rate on a time axis.

### Advantageous Effects of Invention

The present invention has the effect of enabling a project risk to be more preferably detected and output on the basis of general text information generated with the progress of a project.

### BRIEF DESCRIPTION OF DRAWINGS

FIG. 1 is a block diagram illustrating a configuration of an information-processing system according to a first example embodiment of the present invention.

FIG. 2 is a diagram illustrating an example of message data in the first example embodiment.

FIG. 3 is a diagram illustrating an example of a feature representation table in the first example embodiment.

FIG. 4 is a diagram illustrating an example of a totalization result table in the first example embodiment.

FIG. 5 is a diagram illustrating an example of a detection rule table in the first example embodiment.

FIG. 6 is a block diagram illustrating a hardware configuration of a computer that implements the information-processing system according to the first example embodiment.

FIG. 7 is a flowchart illustrating the operation of the information-processing system according to the first example embodiment.

FIG. 8 is a diagram for explaining a method for determining the parameters of a detection rule in the first example embodiment.

FIG. 9 is a diagram illustrating another example of a record in the detection rule table in the first example embodiment.

FIG. 10 is a block diagram illustrating a configuration of an information-processing system according to an alternative example of the first example embodiment.

FIG. 11 is a block diagram illustrating a configuration of an information-processing system according to a second example embodiment of the present invention.

FIG. 12 is a diagram illustrating an example of process information in the second example embodiment.

FIG. 13 is a diagram illustrating an example of a detection rule table in the second example embodiment.

FIG. 14 is a diagram illustrating another example of a record in the detection rule table in the second example embodiment.

FIG. 15 is a block diagram illustrating a configuration of an information-processing system according to an alternative example of the second example embodiment.

### DESCRIPTION OF EMBODIMENTS

Embodiments of the present invention will be described in detail with reference to the drawings. In each drawing and each example embodiment described in the description, similar components are denoted by similar reference numerals, and the descriptions thereof are omitted as appropriate. Further, the direction of each arrow in the drawings is illustrated as an example, and is not intended to limit the direction of a signal between blocks.

### First Example Embodiment

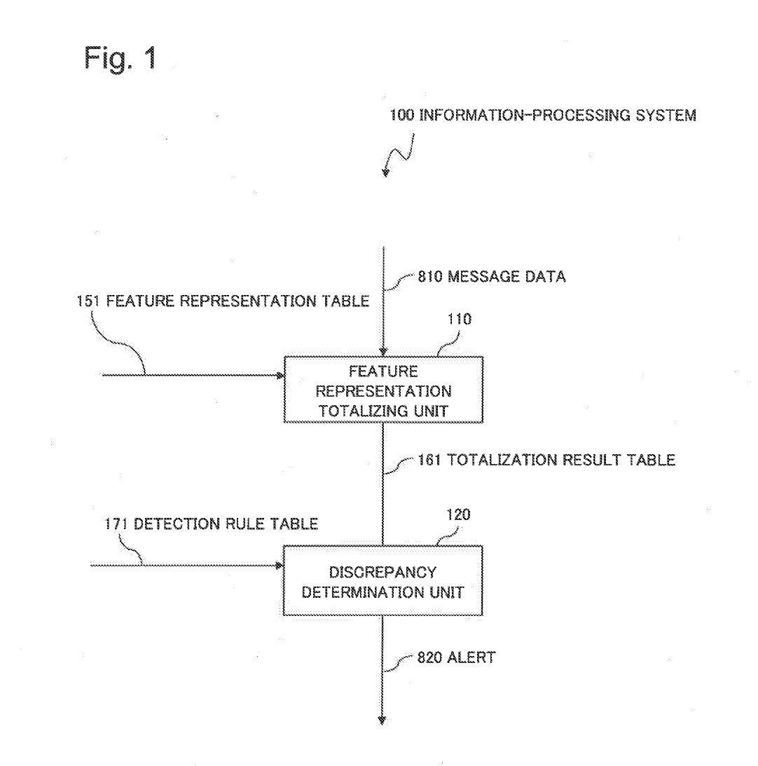

FIG. 1 is block diagram illustrating the configuration of an information-processing system 100 according to a first example embodiment of the present invention.

The information-processing system 100 according to the present example embodiment includes a feature representation totalizing unit 110 and a discrepancy determination unit 120, as illustrated in FIG. 1. Respective components illustrated in FIG. 1 may be circuits in hardware units, or may be components into which a computer apparatus is divided in functional units. Components illustrated in FIG. 1 will now be described as the components into which the computer apparatus is divided in the functional units.

### Feature Representation Totalizing Unit 110

On the basis of a set of a message and the time of occurrence of the message, and pieces of feature representation information indicating feature representations relating to respective processes, the feature representation totalizing unit 110 totalizes the occurrence frequencies of the feature representations relating to the processes.

The message is, for example, general text information that is included in electronic mail, a document file, or the like and that is generated with the progress of a project.

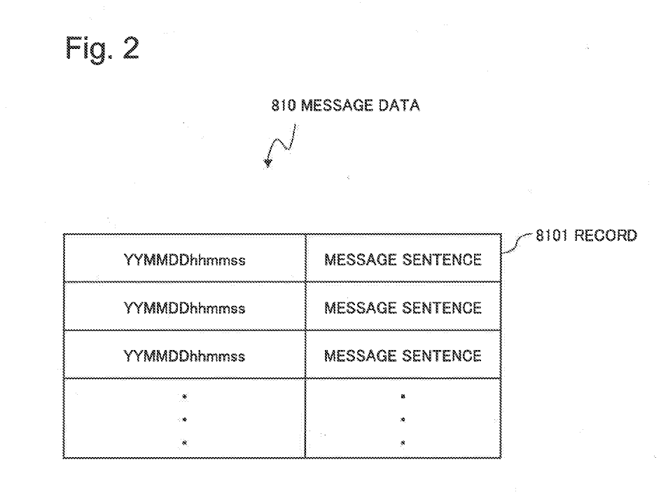

FIG. 2 is a diagram illustrating an example of message data 810 including sets of such messages and the times of the occurrence of the messages. the message data 810 includes a record 8101, as illustrated in FIG. 2. the record 8101 is a set of the time of occurrence, “YYMMDDhhmmss” representing each of year, month, day, hour, minute, and second in double figures, and a message.

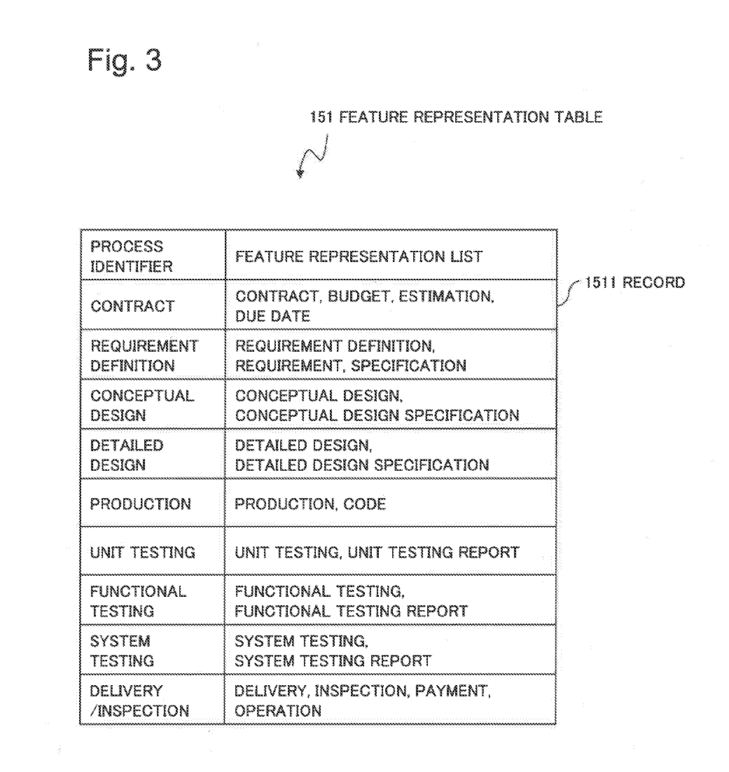

FIG. 3 is a diagram illustrating an example of a feature representation table 151 which is feature representation information. The feature representation table 151 includes records 1511, as illustrated in FIG. 3. Each the record 1511 is a set of a process identifier and a feature representation list relating to the process identifier.

The feature representation table 151 may include any process identifier and any feature representation (in the feature representation list) regardless of the example illustrated in FIG. 3.

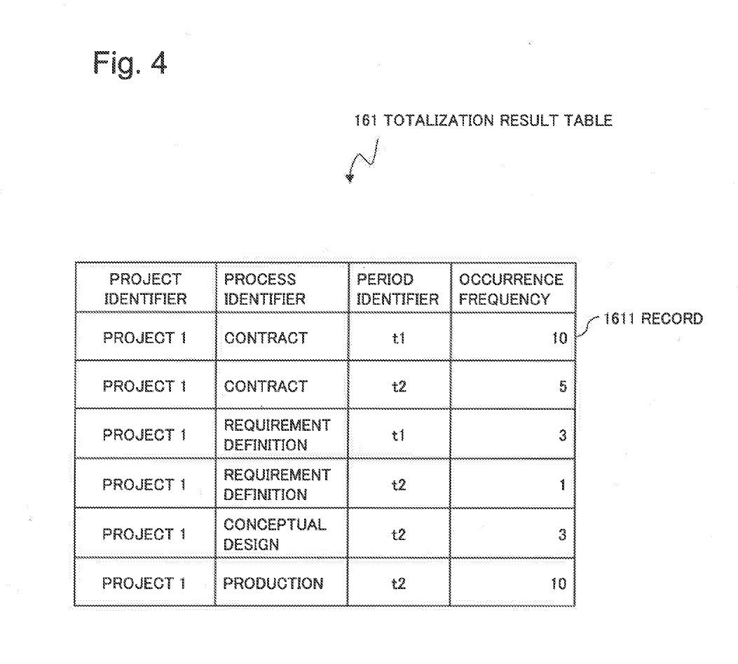

FIG. 4 is a diagram illustrating an example of a totalization result table 161, which is an example of the result of totalizing occurrence frequencies by the feature representation totalizing unit 110. The totalization result table 161 includes records 1611, as illustrated in FIG. 4. Each the record 1611 includes a project identifier, a process identifier, a period identifier, and an occurrence frequency. The details of the occurrence frequency are described later.

For example, the feature representation totalizing unit 110 totalizes the occurrence frequency of a feature representation included in the message of the input message data 810 for each period specified by the period identifier, on the basis of the feature representation table 151. The period specified by the period identifier may be a predetermined interval such as a day or an hour. The period specified by the period identifier may also be any time separated by any selected times of day.

### Discrepancy Determination Unit 120

The discrepancy determination unit 120 outputs information relating to a discrepancy between the ideal and actual states of the process on the basis of an occurrence rate calculated from an occurrence frequency (for example, totalization result table 161) totalized by the feature representation totalizing unit 110 and on the basis of a detection rule. The occurrence rate reflects the actual state of the process. The detection rule defines a time-axis relationship between the process and the occurrence rate, relating to the ideal state of the process. The information relating to the discrepancy between the ideal and actual states of the process is, for example, an alert indicating the occurrence of a project risk.

In other words, the discrepancy determination unit 120 applies to the detection rule, the occurrence rate calculated from the occurrence frequency, thereby determining whether or not the detection rule is applicable to the occurrence frequency. When the detection rule is applicable to the occurrence frequency, the discrepancy determination unit 120 then determines that the discrepancy between the ideal and actual states of the process has reached a state in which it is necessary to alert an administrator, and outputs an alert. If the detection rule is not applicable to the occurrence frequency, the discrepancy determination unit 120 may output information indicating that any project risk has not occurred.

The details of applicability of the detection rule to the occurrence frequency are described later.

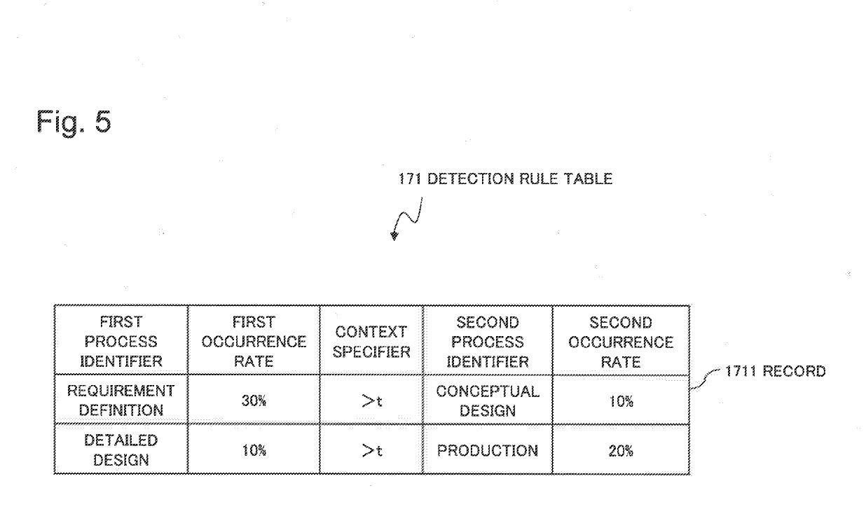

FIG. 5 is a diagram illustrating an example of a detection rule table 171. The detection rule table 171 includes a record 1711, as illustrated in FIG. 5. The record 1711 includes a first process identifier, a first occurrence rate, a context specifier, a second process identifier, and a second occurrence rate.

The first occurrence rate is the rate of occurrence of a feature representation relating to the first process identifier, calculated from the occurrence frequency of the feature representation. The second occurrence rate is the rate of occurrence of a feature representation relating to the second process identifier, calculated from the occurrence frequency of the feature representation. The details of the occurrence rates are described later.

The context specifier indicates the context of a position on a time axis between the first occurrence rate and the second occurrence rate.

The respective components of the information-processing system 100 in the functional units have been described above.

The components of the information-processing system 100 in hardware units will now be described.

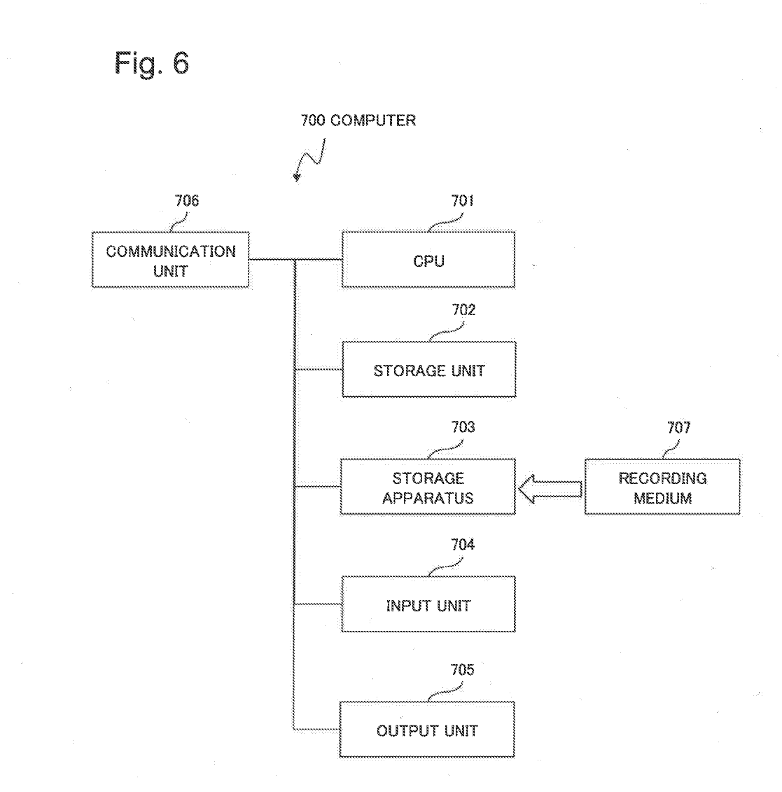

FIG. 6 is a diagram illustrating a hardware configuration of a computer 700 that implements the information-processing system 100 in the present example embodiment.

The computer 700 includes a CPU (Central Processing Unit) 701, a storage unit 702, a storage apparatus 703, an input unit 704, an output unit 705, and a communication unit 706, as illustrated in FIG. 6. The computer 700 further includes a recording medium (or storage medium) 707 which is externally supplied. For example, the recording medium 707 is a nonvolatile recording medium (non-transitory recording medium) in which information is stored in a non-transitory manner. The recording medium 707 may be a transitory recording medium in which information is stored as a signal.

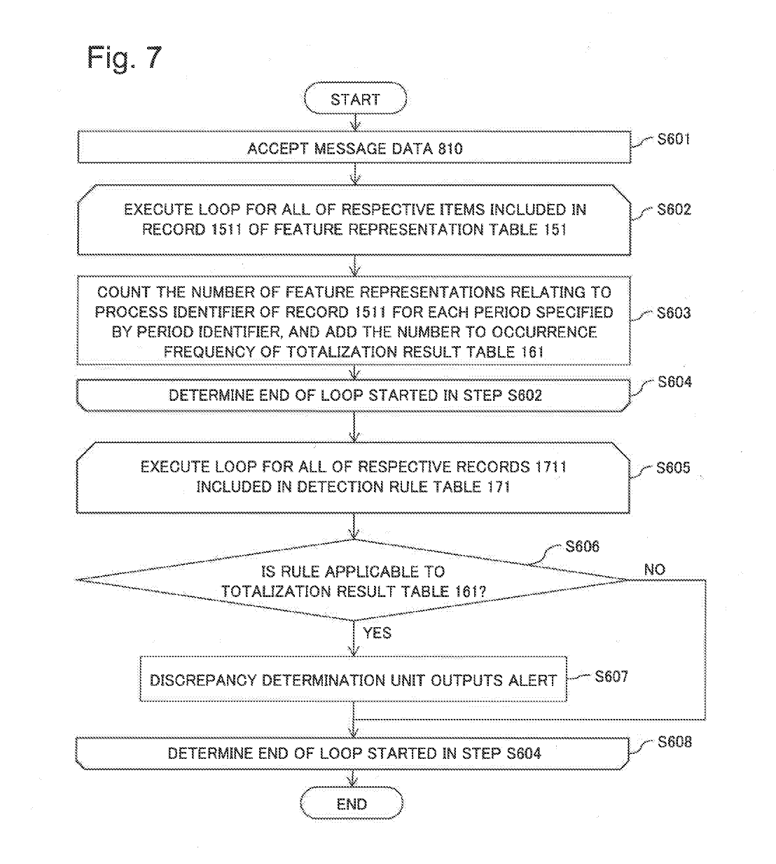

The CPU 701 operates an operating system (not illustrated) to control the overall operation of the computer 700. For example, the CPU 701 reads a program or data from the recording medium 707 mounted to the storage apparatus 703, and writes the read program or data into the storage unit 702. The program is, for example, a program for causing the computer 700 to execute the operation of a flowchart illustrated in FIG. 7 below.

The CPU 701 executes various kinds of processing as the feature representation totalizing unit 110 and the discrepancy determination unit 120 illustrated in FIG. 1, in accordance with the read program or on the basis of the read data.

The CPU 701 may download the program and the data from an external computer (not illustrated) connected to a communication network (not illustrated) to the storage unit 702.

The storage unit 702 stores the program and the data. The storage unit 702 may store the message data 810, the feature representation table 151, the totalization result table 161, and the detection rule table 171.

The storage unit 702 may be included as part of the feature representation totalizing unit 110 and the discrepancy determination unit 120.

The storage apparatus 703 is, for example, an optical disc, a flexible disk, a magneto-optical disk, an external hard disk, semiconductor memory, or the like. The storage apparatus 703 stores the program in a computer-readable form. The storage apparatus 703 may also store the data. The storage apparatus 703 may store the message data 810, the feature representation table 151, the totalization result table 161, and the detection rule table 171. The storage unit 702 may be included as part of the feature representation totalizing unit 110 and the discrepancy determination unit 120.

The input unit 704 accepts an input through manipulation by an operator or the input of external information. a device used for the input manipulation is, for example, a mouse, a keyboard, a built-in keybutton, a touch panel, or the like. The input unit 704 may be included as part of the feature representation totalizing unit 110 and the discrepancy determination unit 120.

The output unit 705 is implemented by, for example, a display. The output unit 705 is used for, for example, an input request to an operator through a GUI (GRAPHICAL User Interface), or an output presentation to the operator. The output unit 705 may be included as part of the feature representation totalizing unit 110 and the discrepancy determination unit 120.

The communication unit 706 implements an interface to an external system. The communication unit 706 may be included as part of the feature representation totalizing unit 110 and the discrepancy determination unit 120.

As described above, the blocks of the functional units of the information-processing system 100 illustrated in FIG. 1 are implemented by the computer 700 including the hardware configuration illustrated in FIG. 6. However, means for implementing each unit included in the computer 700 is not limited to the above. In other words, the computer 700 may be implemented by a physically coupled apparatus, or may be implemented by plural apparatuses which are two or more physically separated apparatuses linked by wired or wireless connections.

When the recording medium 707 on which the code of the program described above is recorded is supplied to the computer 700, the CPU 701 may read and execute the code of the program stored in the recording medium 707. Alternatively, the CPU 701 may store, in the storage unit 702, the storage apparatus 703, or both thereof, the code of the program stored in the recording medium 707. In other words, the present example embodiment encompasses an example embodiment of the recording medium 707 in which the program (software) executed by the computer 700 (CPU 701) is stored in a transitory or non-transitory manner. a storage medium in which information is stored in a non-transitory manner is also referred to as a nonvolatile storage medium.

The respective components, in the hardware units, of the computer 700 that implements the information-processing system 100 in the present example embodiment have been described above.

The operation of the present example embodiment will now be described in detail with reference to the drawings.

FIG. 7 is a flowchart illustrating the operation of the present example embodiment. The processing in the flowchart may be executed in accordance with program control by the CPU 701 described above. The step name of the processing is denoted by a symbol such as S601.

The information-processing system 100 starts the operation of the flowchart illustrated in FIG. 7 when each of the periods specified by the period identifiers described above ends. The information-processing system 100 may start the operation of the flowchart illustrated in FIG. 7 when receiving an instruction from a manipulator via the input unit 704 illustrated in FIG. 6. The information-processing system 100 may start the operation of the flowchart illustrated in FIG. 7 when receiving an external request via the communication unit 706 illustrated in FIG. 6.

The feature representation totalizing unit 110 receives the message data 810 (step S601).

For example, the message data 810 may be stored in advance in the storage unit 702 or the storage apparatus 703 illustrated in FIG. 6. The feature representation totalizing unit 110 may obtain the message data 810 input via the input unit 704 illustrated in FIG. 6 by a manipulator. The feature representation totalizing unit 110 may receive the message data 810 from equipment that is not illustrated, via the communication unit 706 illustrated in FIG. 6. The feature representation totalizing unit 110 may obtain the message data 810 recorded on the recording medium 707, via the storage apparatus 703 illustrated in FIG. 6.

Then, the feature representation totalizing unit 110 subjects each of all the records 1511 included in the feature representation table 151 to the processing of step S603 (step S602).

Then, the feature representation totalizing unit 110 counts the number of feature representations relating to a process identifier in one record 1511 in the message data 810 for each of the periods specified by the period identifiers described above. Subsequently, the feature representation totalizing unit 110 adds the counted value to the occurrence frequency of the record 1611 to which the project identifier, the process identifier, and the period identifier relate, in the totalization result table 161 (step S603).

Then, the feature representation totalizing unit 110 executes determination of the end of the loop started in step S602 (step S604).

When it is determined in step S604 that all the records 1511 have been subjected to the processing of step S603, the processing ends the loop, and proceeds to next step S605. When it is determined in step S604 that there remains any record 1511 that has not been subjected to the processing of step S603, the processing continues the loop so that the feature representation totalizing unit 110 executes the processing of step S603 for the record 1511.

Then, the discrepancy determination unit 120 executes the processing of step S606 to step S607 by a rule indicated in each of all the records 1711 included in the detection rule table 171 (step S605).

For example, the detection rule table 171 may be stored in advance in the storage unit 702 or the storage apparatus 703 illustrated in FIG. 6. The discrepancy determination unit 120 may obtain the detection rule table 171 created, by a manipulator, via the input unit 704 illustrated in FIG. 6. The discrepancy determination unit 120 may receive the detection rule table 171 from equipment that is not illustrated, via the communication unit 706 illustrated in FIG. 6. The discrepancy determination unit 120 may obtain the detection rule table 171 recorded on the recording medium 707, via the storage apparatus 703 illustrated in FIG. 6.

The discrepancy determination unit 120 determines whether or not the rule of the record 1711 is applicable to the content of the totalization result table 161 (step S606).

When the rule of the record 1711 is applicable to the content of the totalization result table 161 (YES in step S606), the discrepancy determination unit 120 outputs an alert (step S607). Then, the processing proceeds to determination of the end of the loop started in step S605.

For example, the discrepancy determination unit 120 outputs the alert via the output unit 705 illustrated in FIG. 6. The discrepancy determination unit 120 may send the alert to equipment that is not illustrated, via the communication unit 706 illustrated in FIG. 6. The discrepancy determination unit 120 may record the alert on the recording medium 707 via the storage apparatus 703 illustrated in FIG. 6.

When the rule of the record 1711 is not applicable to the content of the totalization result table 161 (NO in step S606), the processing proceeds to step 5608.

When the rule of the record 1711 is not applicable to the content of the totalization result table 161 (NO in step S606), the discrepancy determination unit 120 may output information indicating that any project risk has not occurred.

Then, the discrepancy determination unit 120 executes determination of the end of the loop started in step S605 (step S608). When it is determined in step S608 that all the records 1711 have been subjected to the processing of step S606 to step S607, the processing ends the loop, and the processing illustrated in FIG. 7 is ended. When it is determined in step S607 that there remains any record 1711 that has not been subjected to the processing of step S606 to step S607, the processing continues the loop. In other words, the discrepancy determination unit 120 subjects the remaining record 1711 to the processing of step S606 to step S607.

The manipulation of the present example embodiment has been described above.

The operation of the present example embodiment will now be described with providing specific data.

First, it is assumed that the feature representation table 151 is the feature representation table 151 illustrated in FIG. 3. For example, a software development project generally includes processes such as “contract”, “requirement definition”, “conceptual design”, “detailed design”, “production”, “unit testing”, “functional testing”, “system testing”, and “delivery/inspection”. Examples of the feature representations of “contract” include “contract”, “budget”, “estimation”, and “due date”. Such a feature representation may be a word, a document file name, or a regular expression.

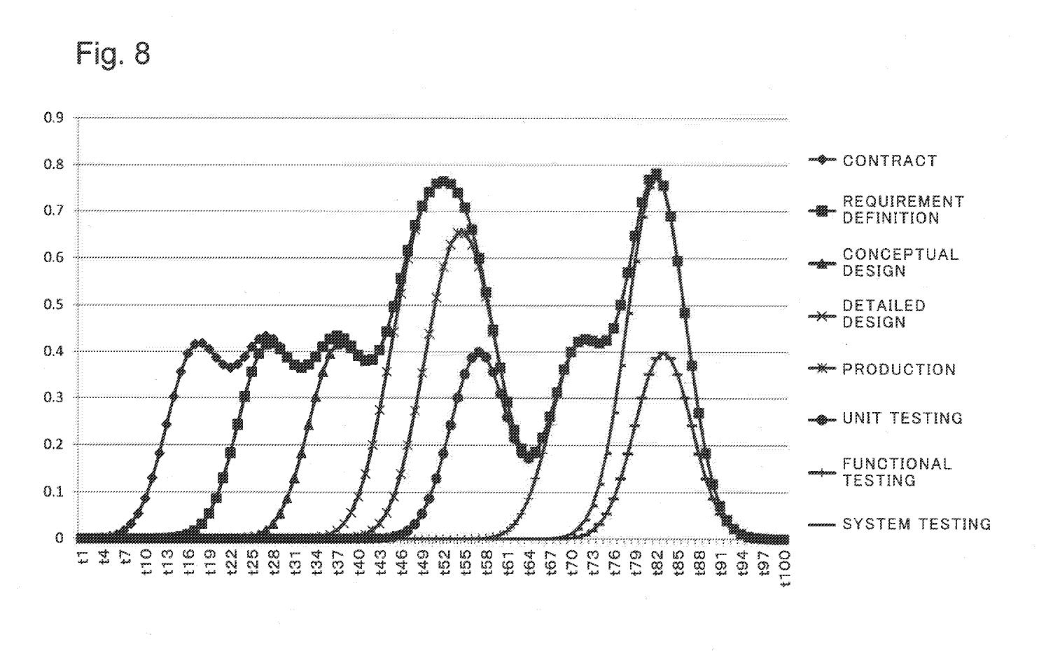

Further, it is assumed that the detection rule table 171 is the detection rule table 171 illustrated in FIG. 5. The detection rule table 171 includes the first process identifier, the first occurrence rate, the second process identifier, the second occurrence rate, and the context specifier. The first process identifier and the second process identifier are process identifiers similar to the process identifier of the feature representation table 151. The first occurrence rate and the second occurrence rate may be determined by a system user, on the basis of registered feature representations and on the assumption of the occurrence frequencies of the feature representations. The system user may determine the first occurrence rate and the second occurrence rate on the basis of, for example, simulation results of modeling the frequencies of the occurrence of the feature representations relating to each process by a normal distribution, based on the schedule of a project. FIG. 8 is a diagram illustrating an example of the simulation results. In FIG. 8, the vertical axis indicates the occurrence frequency of a feature representation relating to each process, and the horizontal axis indicates the period of a project 1.

Then, the feature representation totalizing unit 110 receives, as an input, the message data 810 illustrated in FIG. 2. Then, the feature representation totalizing unit 110 counts the occurrence frequency of a feature representation relating to each process identifier in the feature representation table 151 in the accepted message data 810, and updates the totalization result table 161.

For example, it is assumed that the total occurrence frequency of words of “contract”, “budget”, “estimation”, and “due date” is 10 in an input message during a particular period t1 in the project 1. In this case, the feature representation totalizing unit 110 adds, to the totalization result table 161, a record 1611 in which the project identifier is “project 1”, the process identifier is “contract”, the period identifier is “t1”, and the occurrence frequency is “10”.

It is desirable to use a moving average value as the sum value of occurrence frequencies because the sum value may sharply fluctuate in a short term due to noise. In other words, assuming that the occurrence frequency in a period tj is F_tj, its moving average value F′_tj is calculated as follows: F′_tj={F_(tj−k)+F_(tj−k+1)+F_(tj−k+2)+. . . +F_(tj−1)+F_tj}/(k+1). In this case, k is a window size (also referred to as “predetermined period”) for calculating the moving average, and may be a value that is freely specified by a system user.

Then, the discrepancy determination unit 120 determines whether or not each rule included in the detection rule table 171 is applicable to the content of the totalization result table 161.

For example, the rule defined by the first-line record 1711 of the detection rule table 171 means that “the occurrence rate of the feature representation relating to conceptual design becomes 10% before the occurrence rate of the feature representation relating to a requirement definition becomes 30%”.

With regard to the rule, the discrepancy determination unit 120 executes the following check. First, the discrepancy determination unit 120 calculates FR_tx (requirement definition) and FR_tx (conceptual design) which are occurrence rates respectively relating to “requirement definition” and “conceptual design” in t1 and t2 of the project 1, on the basis of the totalization result table 161, as follows.

FR_t1 (requirement definition)=F_t1 (requirement definition)/F_t1 (*)=3/13=23%

FR_t1 (conceptual design) =F_t1 (conceptual design)/F_t1 (*)=0/13=0%

FR_t2 (requirement definition)=F_t2 (requirement definition)/F_t2 (*)=1/19=5%

FR_t2 (conceptual design)=F_t2 (conceptual design)/F_t2 (*)=3/9=16%

F_tx (requirement definition) is the occurrence frequency of the feature representation of “requirement definition” in tx. F_tx (conceptual design) is the occurrence frequency of the feature representation of “conceptual design” in tx. F_tx (*) is the total of the occurrence frequencies of feature representations in an any process in tx.

In the calculation results described above, neither of the occurrence rates FR_t1 (requirement definition) and FR_t2 (requirement definition) of the feature representation of “requirement definition” in t1 and t2 reaches 30%. In addition, the occurrence rate FR_t2 (conceptual design) of the feature representation of “conceptual design” in t2 reaches 10%. Therefore, the discrepancy determination unit 120 determines that the rule is applicable to the totalization result table 161. Then, the discrepancy determination unit 120 outputs an alert indicating that a project risk has been detected.

The discrepancy determination unit 120 uses the total (F_tx (*)) of feature representations during applicable periods, as a denominator, in the calculation of the occurrence rates described above. However, the discrepancy determination unit 120 may use, as the denominator, the total of the numbers of words during the applicable periods. The discrepancy determination unit 120 may count an occurrence frequency by using, as a unit, not only the number of occurrences or matches of words or regular expressions but also a sentence including or matching the words or the regular expressions. Furthermore, the discrepancy determination unit 120 may count an occurrence frequency by using an email (message) as a unit.

The operation of the present example embodiment has been described above with providing the specific data.

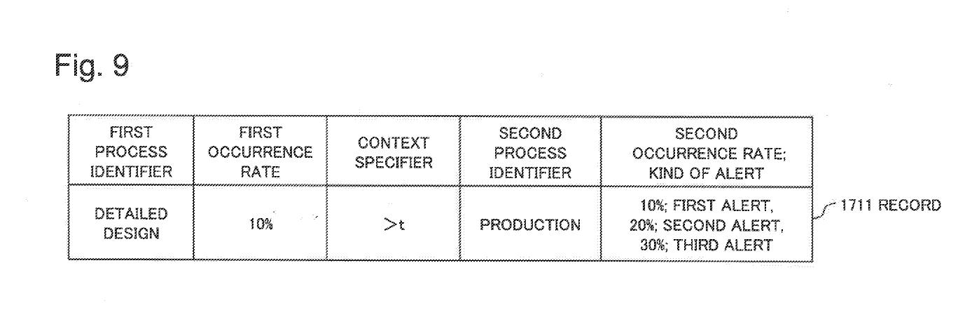

In the present example embodiment, the plural second occurrence rates of a particular record 1711 may be defined in the detection rule table 171. In such a case, the discrepancy determination unit 120 may output an alert relating to the each of plural second occurrence rates. For example, such an alert may be an alert indicating that significance is increased with increasing the value of such a second occurrence rate. FIG. 9 is a diagram illustrating an example of the record 1711 of which the plural second occurrence rates are defined. As illustrated in FIG. 9, the record 1711 includes plural sets of the second occurrence rates and alerts.

A first effect in the present example embodiment is in that it is possible to more preferably detect and output a project risk on the basis of spontaneous text information with regard to the progress of a project.

Specifically, a project risk can be detected even when it is impossible to detect the project risk on the basis of the number of occurrences of input messages, or even when the content of an input message does not include any specific representation representing a problem or a concern. It is possible to provide notification of the detected project risk even when a user does not actively search a message.

This is because the following configuration is included. First, the feature representation totalizing unit 110 generates the totalization result table 161 on the basis of the message data 810 and the feature representation table 151. Second, the discrepancy determination unit 120 outputs information about a discrepancy between the ideal and actual states of a process on the basis of occurrence rates calculated on the basis of the totalization result table 161 and on the basis of the detection rule table 171.

A second effect in the present example embodiment described above is in that it is possible to positively provide notification that any project risk has not occurred.

This is because the discrepancy determination unit 120 outputs information indicating that any project risk has not occurred when the detection rule table 171 is not applicable to the occurrence frequency.

A third effect in the present example embodiment described above is in that it is possible to more accurately provide notification of a project risk.

This is because the feature representation totalizing unit 110 totalizes occurrence frequencies by calculating the moving average value of the occurrence frequencies by using a window size as a unit. In other words, this is because the occurrence frequencies with the reduced influence of short-term fluctuations due to noise are totalized.

A fourth effect in the present example embodiment described above is in that it is possible to provide notification of a project risk with any given degree.

This is because the discrepancy determination unit 120 outputs an alert relating to each of plural respective second occurrence rates defined in the record 1711.

### Alternative Example of First Example Embodiment

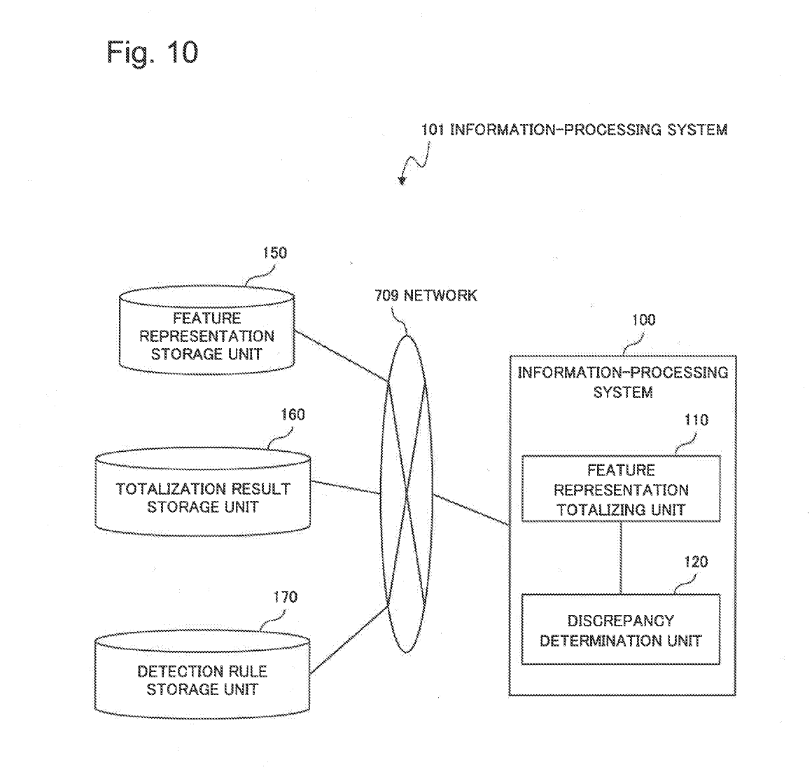

FIG. 10 is a diagram illustrating an information-processing system 101 which is an alternative example of the first example embodiment. As illustrated in FIG. 10, the information-processing system 101 includes the information-processing system 100 as illustrated in FIG. 1, as well as a feature representation storage unit 150, a totalization result storage unit 160, and a detection rule storage unit 170. The information-processing system 100 is connected to the feature representation storage unit 150, the totalization result storage unit 160, and the detection rule storage unit 170 via a network 709. Regardless of an example illustrated in FIG. 10, the information-processing system 100, the feature representation storage unit 150, the totalization result storage unit 160, and the detection rule storage unit 170 may be included in the single computer 700 as illustrated in FIG. 6. Alternatively, the information-processing system 100 may be connected directly to the feature representation storage unit 150, the totalization result storage unit 160, and the detection rule storage unit 170, via no network.

### 32 Feature Representation Storage Unit 150

The feature representation storage unit 150 stores a feature representation table 151.

### Totalization Result Storage Unit 160

The totalization result storage unit 160 stores a totalization result table 161.

### Detection Rule Storage Unit 170

The detection rule storage unit 170 stores a detection rule table 171.

In the present alternative example, a feature representation totalizing unit 110 obtains the feature representation table 151 from the feature representation storage unit 150, and outputs the totalization result table 161 to the totalization result storage unit 160. Further, a discrepancy determination unit 120 obtains the totalization result table 161 from the totalization result storage unit 160, and obtains the detection rule table 171 from the detection rule storage unit 170.

The effect of the alternative example in the present example embodiment described above is in that the information-processing system 101 that detects a project risk can be constructed flexibly (for example, with reduced limitations on an installation location and the like).

This is because the information-processing system 100 is connected to the feature representation storage unit 150, the totalization result storage unit 160, and the detection rule storage unit 170 via the network 709.

### Second Example Embodiment

A second example embodiment of the present invention will now be described in detail with reference to the drawings. The description of a content overlapping the description described above will be omitted below unless the description of the present example embodiment becomes unclear.

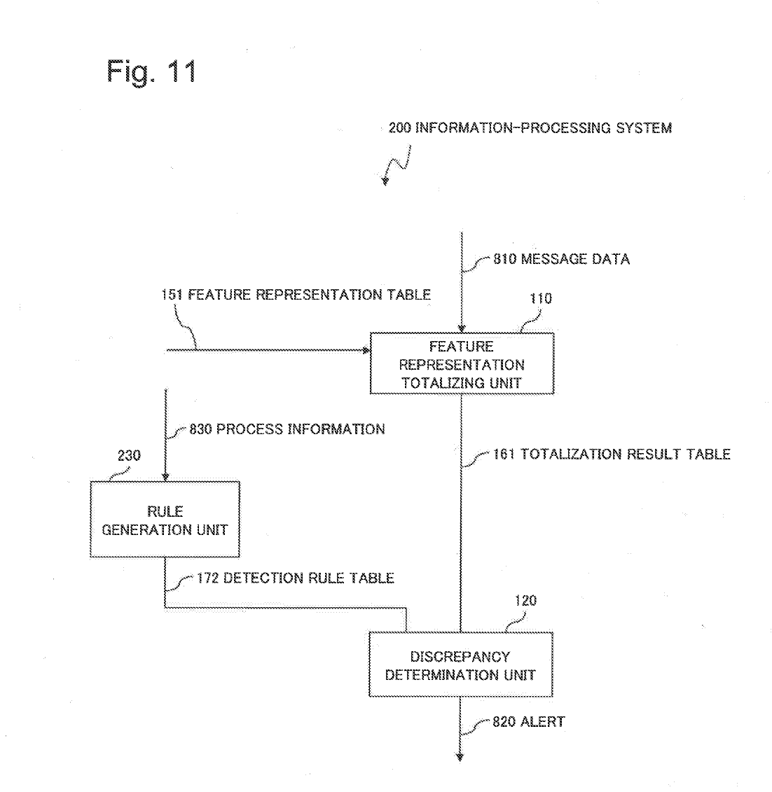

FIG. 11 is a block diagram illustrating the configuration of an information-processing system 200 according to the second example embodiment of the present invention.

As illustrated in FIG. 11, the information-processing system 200 in the present example embodiment differs from the information-processing system 100 of the first example embodiment in that the information-processing system 200 further includes a rule generation unit 230.

### Rule Generation Unit 230

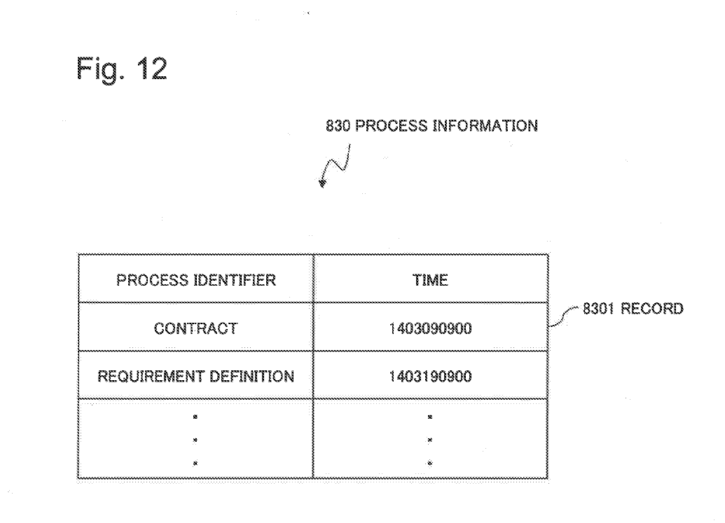

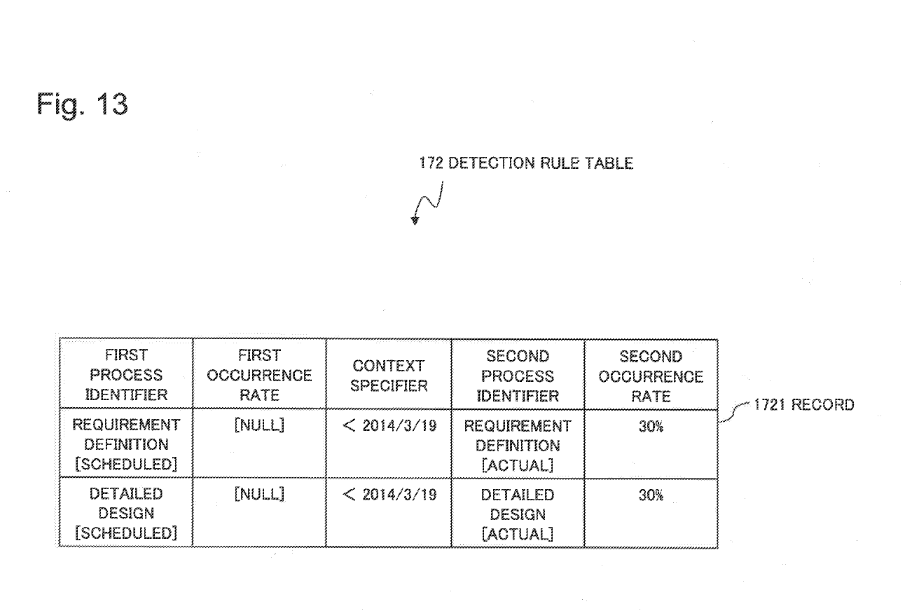

The rule generation unit 230 generates such a detection rule table 172 as, for example, illustrated in FIG. 13, on the basis of such process information 830 as, for example, illustrated in FIG. 12. For example, the process information 830 is a process table including an arbitrary number of sets of process identifiers and scheduled implementation dates (times in FIG. 12). The process information 830 may be a report including an arbitrary number of sets of process identifiers and reported implementation completion dates (times in FIG. 12). Hereinafter, “set of process identifier and scheduled implementation date”, “set of process identifier and reported implementation completion date”, and the like are generically referred to as “set of process identifier and time”.

FIG. 12 is a diagram illustrating an example of the process information 830. The process information 830 includes a record 8301, as illustrated in FIG. 12. The record 8301 includes a process identifier and the time of starting a process specified by the process identifier.

FIG. 13 is a diagram illustrating an example of the detection rule table 172. The detection rule table 172 includes an arbitrary number of records 1721, as illustrated in FIG. 13. The rule generation unit 230 generates the detection rule table 172, for example, in the following procedure.

First, the rule generation unit 230 extracts a set (record 8301) of a process identifier and a time from the process information 830.

Second, the rule generation unit 230 registers the record 1721 of the detection rule table 172 for, for example, each of the records 8301 of the process information 830. For example, the rule generation unit 230 sets the first process identifier of such a record 1721 at the process identifier of such a record 8301 in the form of “process identifier [scheduled]”. Further, the rule generation unit 230 sets the first occurrence rate, the context specifier, the second process identifier, and the second occurrence rate of the record 1721 respectively at “[NULL]”, “<time”, “process identifier [actual]”, and “30%”, respectively. In such a case, [NULL] means a blank. “<Time” of the context specifier relates to the time of the record 8301, and is expressed in the form of “<date in year, month, and day format”. In other words, the context specifier in this case indicates a specific time. Further, “30%” of the second occurrence rate is a specified value that is specified in advance by a system user. The specified value may be any value regardless of the example described above.

The registered rule means “the occurrence rate of the feature representation relating to the second process identifier becomes the second occurrence rate after the date of ‘< date in year, month, and day format’ without regard to the first process identifier and the first occurrence rate by specifying the first occurrence rate as ‘NULL’”. In other words, the rule means “the context of the feature representation occurrence rate, which becomes the value of the second occurrence rate, relating to the process indicated by the second process identifier with respect to a specific time on a time axis.

The context specifier may include, for example, hour, minute, second, and the like regardless of the example described above. In the context specifier, “>time” may be selected by a system user. In such a case, the context specifier indicates “before the time”.

The rule generation unit 230 may generate such a record 1711 as illustrated in FIG. 5 in a manner similar to that in the above description.

A detection rule table 171 illustrated in FIG. 5 may include such a record 1721 as illustrated in FIG. 13.

Like the information-processing system 100, the information-processing system 200 may be implemented by a computer 700 illustrated in FIG. 6.

In this case, a CPU 701 further executes various kinds of processing as the rule generation unit 230 illustrated in FIG. 11.

A storage unit 702 may further store the process information 830 and the detection rule table 172. The storage unit 702 may be further included as part of the rule generation unit 230.

A storage apparatus 703 may further store the process information 830 and the detection rule table 172. The storage apparatus 703 may be further included as part of the rule generation unit 230.

An input unit 704 may be further included as part of the rule generation unit 230.

An output unit 705 may be further included as part of the rule generation unit 230.

A communication unit 706 may be further included as part of the rule generation unit 230.

The operation of the present example embodiment will now be described with providing specific data.

The process information 830 illustrated in FIG. 12 is regarded as an input.

For example, the rule generation unit 230 obtains the process information 830 input by a manipulator, via the input unit 704 illustrated in FIG. 6. The process information 830 may be stored in advance in the storage unit 702 or the storage apparatus 703 illustrated in FIG. 6. The rule generation unit 230 may receive the process information 830 from equipment that is not illustrated, via the communication unit 706 illustrated in FIG. 6. The rule generation unit 230 may obtain the process information 830 recorded on a recording medium 707, via the storage apparatus 703 illustrated in FIG. 6.

The rule generation unit 230 extracts a set of a time and a process identifier from the process information 830. For example, it is assumed that the rule generation unit 230 extracts a record 8301 including a process identifier being a “requirement definition”.

In such a case, the rule generation unit 230 registers the record 1721 of “requirement definition [scheduled], [NULL], <2014/3/19, requirement definition [actual], 30%” on the basis of the record 8301.

The registered rule means that “the occurrence rate of the feature representation relating to requirement definition becomes 30% after 2014/3/19^{th}”.

The operation of the present example embodiment has been described above with providing the specific data.

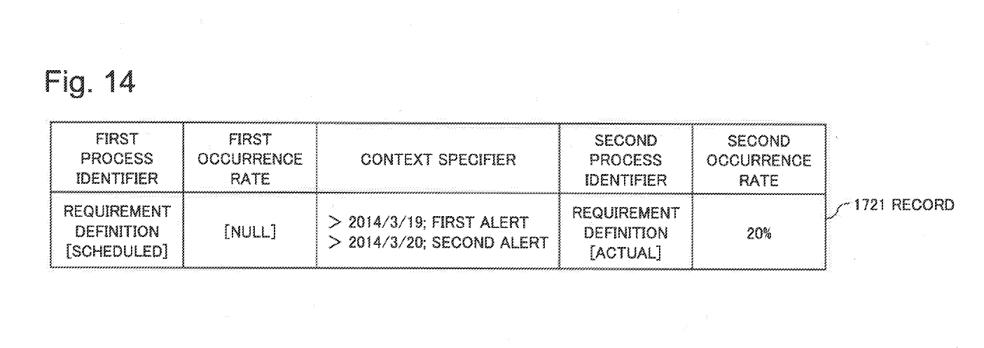

In the present example embodiment and its alternative example described later, plural context specifiers in a particular record 1721 may be defined in the detection rule table 172. In such a case, a discrepancy determination unit 120 may output an alert relating to each of the plural context specifiers. For example, such an alert may be an alert indicating that significance is enhanced with the relative progression of the time of such a context specifier. FIG. 14 is a diagram illustrating an example of a record 1721 in which plural context specifiers are defined. As illustrated in FIG. 14, the record 1721 includes plural sets of the context specifiers and alerts.

A first effect in the present example embodiment described above is in that in addition to the effect of the first example embodiment, a project risk can be detected with reduced human intervention.

This is because the rule generation unit 230 generates a detection rule on the basis of an input such as a process table, a report, or the like.

A second effect in the present example embodiment described above is in that it is possible to provide notification of a project risk with any given degree.

This is because the discrepancy determination unit 120 outputs an alert relating to each of plural context specifiers defined in the record 1711.

### Alternative Example of Second Example Embodiment

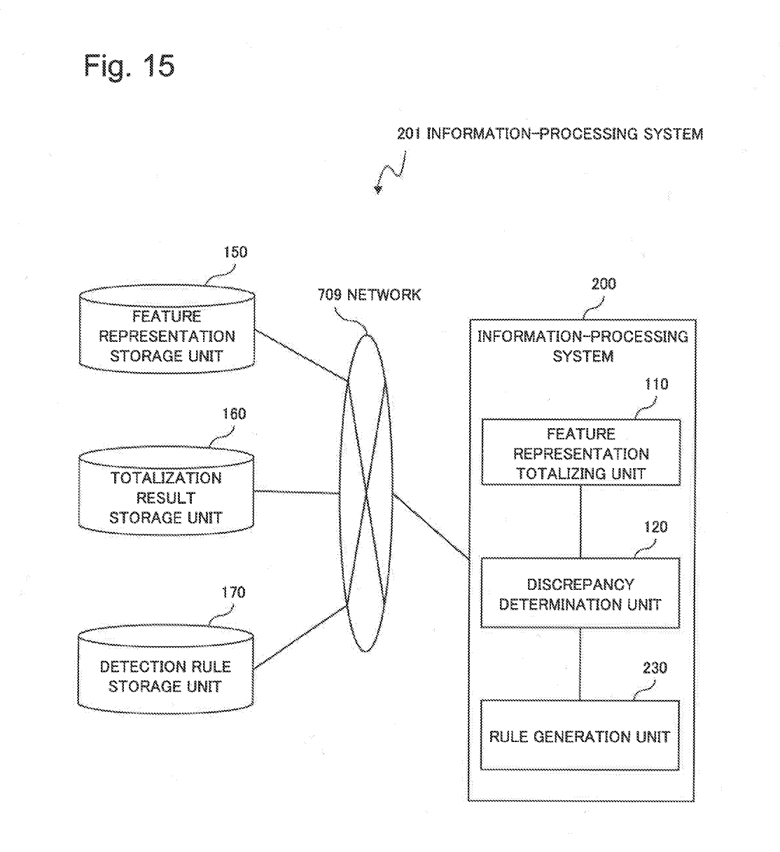

FIG. 15 is a diagram illustrating an information-processing system 201 which is an alternative example of the second example embodiment. As illustrated in FIG. 15, the information-processing system 201 includes an information-processing system 200 illustrated in FIG. 11, as well as a feature representation storage unit 150, a totalization result storage unit 160, and a detection rule storage unit 170. The information-processing system 200 is connected to the feature representation storage unit 150, the totalization result storage unit 160, and the detection rule storage unit 170 via a network 709. Regardless of an example illustrated in FIG. 15, the information-processing system 200, the feature representation storage unit 150, the totalization result storage unit 160, and the detection rule storage unit 170 may be included in such a single computer 700 as illustrated in FIG. 6. Alternatively, the information-processing system 200 may be connected directly to the feature representation storage unit 150, the totalization result storage unit 160, and the detection rule storage unit 170, via no network.

In the present alternative example, a rule generation unit 230 stores a generated detection rule table 172 in the detection rule storage unit 170.

The effect of the alternative example in the present example embodiment described above is in that the information-processing system 201 that detects a project risk can be constructed flexibly (for example, with reduced limitations on an installation location and the like).

This is because the information-processing system 200 is connected to the feature representation storage unit 150, the totalization result storage unit 160, and the detection rule storage unit 170 via the network 709.

The components illustrated in each of the above example embodiments need not be independent of each other. For example, any plural components of the components may be implemented as a module. Any one of the components may be implemented as plural modules. Any one of the components may be any other one of the components. Part of any one of the components and part of any other one of the components may overlap one another.

If possible, each component and a module that implements each component in each of the example embodiments described above may be implemented as hardware, as needed. Each component and the module that implements each component may be implemented by a computer and a program. Each component and the module that implements each component may be implemented by mixing a module as hardware with the computer and the program.

The program is recorded on a non-transitory computer-readable recording medium such as, for example, a magnetic disk or semiconductor memory, and is provided to the computer. The program is read from the non-transitory recording medium into the computer when, e.g., the computer is booted up. The read program functionalizes the computer as a component in each of the example embodiments described above by controlling the operation of the computer.

The plural operations are described in turn in the form of the flowchart in each of the example embodiments described above.

However, the described order does not limit the order of executing the plural operations. Therefore, the order of the plural operations can be changed unless constituting a substantial hindrance when each example embodiment is carried out.

Furthermore, each of the example embodiments described above is not limited to the execution of the plural operations at individually different timings. For example, during executing a certain operation, another operation may occur. The timings of executing a certain operation and another operation may partly or entirely overlap one another.

Furthermore, it is described that a certain operation serves as the impetus for another operation, in each of the example embodiments described above. However, the description is not intended to limit a relationship between the certain operation and the other operation. Therefore, the relationship between the plural operations can be changed unless constituting a substantial hindrance when each example embodiment is carried out. Further, the specific description of each operation of each component is not intended to limit each operation of each component. Therefore, each specific operation of each component can be changed unless constituting a substantial hindrance to functional, performance, and other characteristics when each example embodiment is carried out.

The present invention has been described above with reference to each example embodiment. However, the present invention is not limited to the example embodiments described above. The constitution and details of the present invention can be subjected to various modifications that can be understood by a person skilled in the art within the scope of the present invention.

This application claims priority based on Japanese Patent Application No. 2014-160068, which was filed on Aug. 6, 2014, and of which the entire disclosure is incorporated herein.

### REFERENCE SIGNS LIST

100 Information-processing system
101 Information-processing system
110 Feature representation totalizing unit
120 Discrepancy determination unit
150 Feature representation storage unit
151 Feature representation table
160 Totalization result storage unit
161 Totalization result table
170 Detection rule storage unit
171 Detection rule table
172 Detection rule table
200 Information-processing system
201 Information-processing system
230 Rule generation unit
700 Computer
701 CPU
702 Storage unit
703 Storage apparatus
704 Input unit
705 Output unit
706 Communication unit
707 Recording medium
709 Network
810 Message data
830 Process information
1511 Record
1611 Record
1711 Record
1721 Record
8101 Record
8301 Record

1. An information-processing system comprising:
one or more processors acting as feature representation totalizing unit configured to totalize an occurrence frequency of a feature representation related to each process based on a set of a message and a time of occurrence of the message, and on feature representation information indicating the feature representation related to the process; and
the one or more processors acting as discrepancy determination unit configured to output information about discrepancy between ideal and actual states of the process based on an occurrence rate calculated from the occurrence frequency related to the process and on a detection rule that defines a position of the occurrence rate on a time axis.

2. The information-processing system according to claim 1, further comprising:
the one or more processors acting as rule generation unit configured to generate the detection rule based on information indicating a relation between the process and a time.

3. The information-processing system according to claim 2, further comprising:
the one or more processors acting as input unit configured to input information indicating a relation between the process and a time,
wherein the information arbitrarily comprises a set of the process and a scheduled implementation date, and a set of the process and a reported implementation completion date.

4. The information-processing system according to claim 1, wherein
the detection rule comprises a definition of a context of the occurrence rate of the feature representation related to the process with respect to a specific time, on a time axis.

5. The information-processing system according to 1, wherein
the detection rule comprises a definition of a context of the occurrence rate related to each of the two processes, on a time axis.

6. The information-processing system according to claim 1, wherein
the feature representation totalizing unit totalizes the occurrence frequency of the feature representation by calculating a moving average value of the occurrence frequency of the feature representation by using a predetermined period as a unit.

7. The information-processing system according to claim 1, wherein
the detection rule defines positions of the occurrence rates comprising a plurality of values on the time axis; and
the discrepancy determination unit outputs information about the discrepancy relating to each of the values of the occurrence rates.

8. The information-processing system according to claim 1, wherein
the detection rule defines positions of the plurality of occurrence rates with respect to the specific process on a time axis; and
the discrepancy determination unit outputs information about the discrepancy relating to each of the positions.

9. A project risk detection method comprising:
totalizing an occurrence frequency of a feature representation related to each process based on a set of a message and a time of occurrence of the message, and on feature representation information indicating the feature representation related to the process; and
outputting information about discrepancy between ideal and actual states of the process based on an occurrence rate calculated from the occurrence frequency related to the process and on a detection rule that defines a position of the occurrence rate on a time axis.

10. A non-transitory computer-readable recording medium on which a program is recorded that causes a computer to execute processing of:
totalizing an occurrence frequency of a feature representation related to each process based on a set of a message and a time of occurrence of the message, and on feature representation information indicating the feature representation related to the process; and
outputting information about discrepancy between ideal and actual states of the process based on an occurrence rate calculated from the occurrence frequency related to the process and on a detection rule that defines a position of the occurrence rate on a time axis.

11. The information-processing system according to claim 2, wherein
the detection rule comprises a definition of a context of the occurrence rate of the feature representation related to the process with respect to a specific time, on a time axis.

12. The information-processing system according to claim 3, wherein
the detection rule comprises a definition of a context of the occurrence rate of the feature representation related to the process with respect to a specific time, on a time axis.

13. The information-processing system according to claim 2, wherein
the detection rule comprises a definition of a context of the occurrence rate related to each of the two processes, on a time axis.

14. The information-processing system according to claim 3, wherein
the detection rule comprises a definition of a context of the occurrence rate related to each of the two processes, on a time axis.

15. The information-processing system according to claim 4, wherein
the detection rule comprises a definition of a context of the occurrence rate related to each of the two processes, on a time axis.

16. The information-processing system according to claim 2, wherein
the feature representation totalizing means totalizes the occurrence frequency of the feature representation by calculating a moving average value of the occurrence frequency of the feature representation by using a predetermined period as a unit.

17. The information-processing system according to claim 3, wherein
the feature representation totalizing means totalizes the occurrence frequency of the feature representation by calculating a moving average value of the occurrence frequency of the feature representation by using a predetermined period as a unit.

18. The information-processing system according to claim 4, wherein
the feature representation totalizing means totalizes the occurrence frequency of the feature representation by calculating a moving average value of the occurrence frequency of the feature representation by using a predetermined period as a unit.

19. The information-processing system according to claim 5, wherein
the feature representation totalizing means totalizes the occurrence frequency of the feature representation by calculating a moving average value of the occurrence frequency of the feature representation by using a predetermined period as a unit.
